(19) United States
(12) Patent Application Publication
(10) Pub. No.: US 2024/0384747 A1
(43) Pub. Date: Nov. 21, 2024

(54) COMPRESSION NUT ASSEMBLIES

(71) Applicant: Production Spring, LLC, Troy, MI (US)

(72) Inventor: Lawrence Johnson, Taylor, MI (US)

(73) Assignee: Production Spring, LLC, Troy, MI (US)

(21) Appl. No.: 18/199,589

(22) Filed: May 19, 2023

(51) Int. Cl. F16B 37/12; F16B 33/02; F16B 37/04

(52) U.S. Cl. CPC F16B 37/125; F16B 33/02; F16B 37/042; F16B 2033/025

(57) ABSTRACT

A compression nut assembly is provided including a base nut and a compression nut. The base nut includes a base shaft having an interior surface and an exterior surface. The interior surface of the base shaft includes a plurality of internal threads extending in a first handedness direction. The compression nut includes a compression shaft having an interior surface and an exterior surface. The exterior surface of the compression shaft includes a plurality of external threads extending in the first handedness direction and engagable with the internal threads of the base shaft. The interior surface of the compression shaft includes a plurality of internal threads extending in a second handedness direction opposite the first handedness direction.

### TECHNICAL FIELD

The present specification generally relates to threaded assemblies and, more specifically, methods for compensating for spaces between opposing objects.

### BACKGROUND

During manufacturing, opposing objects, such as panels, planar members, and the like, may include gaps or spaces therebetween. Over time, movement and vibrations of the objects may result in damage as the opposing objects shift closer to and away from one another. Therefore, components or assemblies may be provided between the opposing objects to compensate for the gap between the objects and prevent movement with respect to one another.

As such, compression nuts may be used to compensate for the spacing between opposing objects. However, compression nuts are generally formed from a plurality of threaded nuts and fasteners and are difficult to assemble. Further, in assembling a compression nut, it may be difficult to align the threads of each nut or fastener within one another.

Accordingly, a need exists for improved threaded assemblies that compensate for spaces between opposing objects to prevent damage during movement and vibrations.

### SUMMARY

In one embodiment, a compression nut assembly includes a base nut including a base shaft having an interior surface and an exterior surface. The interior surface of the base shaft includes a plurality of internal threads extending in a first handedness direction. The compression nut assembly also includes a compression nut including a compression shaft having an interior surface and an exterior surface. The exterior surface of the compression shaft includes a plurality of external threads extending in the first handedness direction and engagable with the internal threads of the base shaft. The interior surface of the compression shaft includes a plurality of internal threads extending in a second handedness direction opposite the first handedness direction.

In another embodiment, a compression nut assembly includes a base nut including a base plate having a first surface and a second surface, and a base shaft extending from the first surface of the base plate. The base shaft has an interior surface and an exterior surface. The interior surface of the base shaft includes a plurality of internal threads extending in a first handedness direction. The compression nut assembly also includes a compression nut including a compression plate having a first surface and a second surface, and a compression shaft extending from the first surface of the compression plate. The compression shaft has an interior surface and an exterior surface. The exterior surface of the compression shaft includes a plurality of external threads extending in the first handedness direction and engagable with the internal threads of the base shaft. The interior surface of the compression shaft includes a plurality of internal threads extending in a second handedness direction opposite the first handedness direction.

In yet another embodiment, a method for expanding a compression nut assembly between a first object and a second object, includes threadedly engaging a compression nut with a base nut. The compression nut includes a plurality of external threads engaging a plurality of internal threads of the base nut. The base nut is fixed to the first object and the compression nut is movable between a retracted state and an extended state. A fastener threadedly engages a plurality of internal threads of the compression nut. The fastener is rotated in a first direction to move the compression nut toward the extended state until the compression nut extends entirely between a space provided between the first object and the second object. The fastener is rotated in the first direction such that the fastener further engages the compression nut.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a compression nut assembly according to one or more embodiments shown and described herein;

FIG. 2 schematically depicts an exploded view of the compression nut assembly according to one or more embodiments shown and described herein;

FIG. 3 schematically depicts the compression nut assembly showing a compression nut in a retracted state with respect to a base nut according to one or more embodiments shown and described herein; and

FIG. 4 schematically depicts the compression nut assembly showing the compression nut in an extended state with respect to the base nut according to one or more embodiments shown and described herein.

### DETAILED DESCRIPTION

Embodiments described herein are directed to threaded assemblies including a base nut and a compression nut that is extendable between a pair of opposing objects, such as panels, or the like, to mitigate damage caused by movement and vibration of the pair of opposing objects with respect to one another.

The threaded assemblies generally include a base nut and a compression nut. The compression nut includes a plurality of external threads engagable with a plurality of internal threads of the base nut. The compression nut also includes a plurality of internal threads arranged in a handedness direction opposite the handedness direction of the internal threads of the base nut and the external threads of the compression nut. Various embodiments of the compression nut assemblies and the operation of the compression nut assemblies are described in more detail herein. Whenever possible, the same reference numerals will be used throughout the drawings to refer to the same or like parts.

As used herein, the term “handedness” when referring to threads of a nut or fastener refers to the twisting direction of a helix of the threads. When viewed from a point of view along the axis of the helix, right-handed threads will result in the nut or fastener moving away from the viewer when it is turned in a clockwise direction and moving toward the viewer when the nut or fastener is turned in a counterclockwise direction. Alternatively, left-handed threads will result in the nut or fastener moving toward the viewer when it is turned in a clockwise direction and moving toward the viewer when the nut or fastener is turned in a counterclockwise direction.

As used herein, the terms “retracted state” and “extended state” refer to the position of the compression nut with respect to the base nut. Specifically, when the compression nut is in the retracted state, a greater number of external threads of the compression nut engage the internal threads of the base nut as compared to the number of external threads of the compression nut that engage the internal threads of the base nut when the compensation nut is in the extended state.

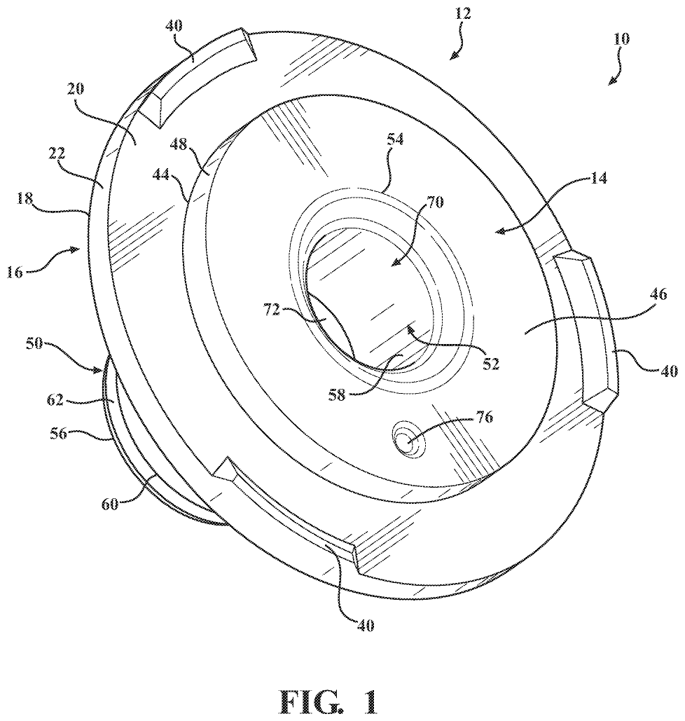

Referring now to FIG. 1, a perspective view of a compression nut assembly 10 is illustrated according to one or more embodiments described herein. The compression nut assembly 10 may generally include a base nut 12 and a compression nut 14 threadedly engaging the base nut 12. As discussed in more detail herein, the compression nut 14 is positionable between a retracted state, in which the compression nut 14 fully engages the base nut 12, and an extended state, in which the compression nut 14 extends out of the base nut 12 to fill a space or gap between two objects, such as a pair of panels, substrates, or other objects. As shown, the base nut 12 and the compression nut 14 each have a generally circular geometry. However, the base nut 12 and the compression nut 14 may each have any suitable geometry, such as square, without deviating from the scope of the present disclosure. In addition, the base nut 12 may have a geometry that differs from the compression nut 14 so long as the compression nut 14 is dimensioned to threadedly engage the base nut 12, as discussed herein.

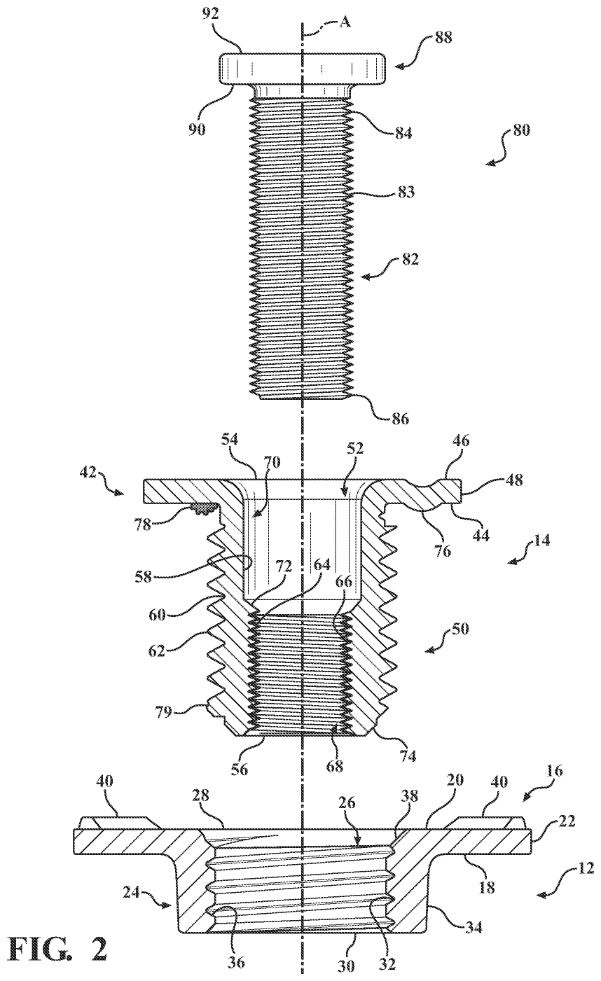

Referring now to FIG. 2, an exploded view of the compression nut assembly 10 is shown. With respect to the base nut 12, the base nut 12 includes a base plate 16 having a first surface 18, an opposite second surface 20, and an edge surface 22 extending between the first surface 18 and the second surface 20. The base nut 12 further includes a base shaft 24 extending from the first surface 18 of the base plate 16 and generally perpendicular thereto. In some embodiments, the base nut 12 does not include the base plate 16.

The base nut 12 has a base channel 26 formed therein and extending in a longitudinal axis A through the base plate 16 and the base shaft 24. Thus, the base channel 26 has a first open end 28 terminating at the second surface 20 of the base plate 16 and an opposite second open end 30 terminating at an end of the base shaft 24 opposite the base plate 16. The base shaft 24 includes an interior surface 32, defining the base channel 26, and an exterior surface 34. A plurality of internal threads 36 are provided on the interior surface 32 of the base shaft 24. The internal threads 36 may extend along an entire length of the base channel 26 and interior surface 32 of the base shaft 24 or only a portion thereof. As discussed in more detail herein, in some embodiments, the internal threads 36 of the base shaft 24 are left-handed threads. In some embodiments, the interior surface 32 of the base shaft 24 includes a chamfer 38 provided at the first open end 28 of the base channel 26.

As discussed herein, the base plate 16 has a generally circular geometry. However, the base plate 16 may have any suitable geometry without limiting the scope of the present disclosure. The base nut 12 may be formed from any suitable material, such as metal, plastic, or the like. In some embodiments, the base nut 12 is an integrally formed, monolithic structure.

In some embodiments, the base nut 12 also includes at least one projection 40 extending from the second surface 20 of the base plate 16. The projection 40 provides a point of contact between the second surface 20 of the base plate 16 and a panel or other objects to which the base nut 12 may be secured or abut against. When the base nut 12 is formed from metal, the projection 40 provides a weld point to secure the base nut 12 to a panel. As shown in FIGS. 1 and 2, there are a plurality of projections 40, specifically three projections 40. In some embodiments, the plurality of projections 40 are provided proximate the edge surface 22 of the base plate 16 and are equidistantly spaced apart from one another. However, the projections 40 may be located in any suitable location and arrangement, such as located closer toward a center of the base plate 16 and closer to the base shaft 24. In embodiments in which the base plate 16 includes at least one projection 40, it should be appreciated that providing at least two opposing projections 40 or a plurality of equidistantly spaced apart projections 40 will improve the stability of the base plate 16 on a panel as opposed to the stability provided by only a single projection 40.

With respect to the compression nut 14, the compression nut 14 includes a compression plate 42 having a first surface 44, an opposite second surface 46, and an edge surface 48 extending between the first surface 44 and the second surface 46. The compression nut 14 further includes a compression shaft 50 extending from the first surface 44 of the compression plate 42 and generally perpendicular thereto. In some embodiments, the compression nut 14 does not include the compression plate 42.

The compression nut 14 has a compression channel 52 formed therein and extending along the longitudinal axis A through the compression plate 42 and the compression shaft 50. Thus, the compression channel 52 has a first open end 54 terminating at the second surface 46 of the compression plate 42 and an opposite second open end 56 terminating at an end of the compression shaft 50 opposite the compression plate 42. The compression shaft 50 includes an interior surface 58, defining the compression channel 52, and an exterior surface 60. A plurality of external threads 62 are provided on the exterior surface 60 of the compression shaft 50 so as to engage the internal threads 36 of the base shaft 24 when the compression nut 14 is inserted into the base nut 12. Therefore, when the plurality of internal threads 36 of the base nut 12 are left-handed threads, the external threads 62 of the compression shaft 50 are also left-handed threads.

The compression shaft 50 also includes a plurality of internal threads 64 formed on at least a portion of the interior surface 58 thereof. In some embodiments, the internal threads 64 of the compression shaft 50 are right-handed threads and opposite that of the external threads 62 of the compression shaft 50 and the internal threads 36 of the base shaft 24. In some embodiments, the internal threads 64 of the compression shaft 50 may include a resistance layer 66, such as an adhesive, film, or other suitable layer of material, overlying the internal threads 64 to increase resistance between the internal threads 64 of the compression shaft 50 and external threads of a fastener, as discussed in more detail herein. The resistance layer 66 may be provided on the entire plurality of threads 64 of the compression shaft 50 or a portion thereof. In some embodiments, the resistance layer 66 may instead be provided on the fastener to be used herewith. The internal threads 64 may extend an entire length of the compression channel 52 and the interior surface 58 of the compression shaft 50 or only a portion thereof. In some embodiments, as shown in FIG. 2, the compression channel 52 has a threaded section 68, including the internal threads 64, and an unthreaded section 70. The unthreaded section 70 of the compression channel 52 has a diameter greater than a diameter of the threaded section 68. Thus, an inclined transition 72 is formed on the interior surface 58 of the compression shaft 50 between the threaded section 68 and the unthreaded section 70. In some embodiments, the exterior surface 60 of the compression shaft 50 includes a chamfer 74 provided at the second open end 56 of the compression channel 52 corresponding to the chamfer 38 formed on the interior surface 32 of the base shaft 24.

As discussed herein, the compression plate 42 has a generally circular geometry. However, the compression plate 42 may have any suitable geometry without limiting the scope of the present disclosure. The compression nut 14 may be formed from any suitable material, such as metal, plastic, or the like.

In some embodiments, the compression nut 14 also includes at least one dimple 76 formed in the compression plate 42 and extending from the first surface 44 thereof in the same direction as the compression shaft 50. In some embodiments, the dimple 76 is formed by a depression in the second surface 46 of the compression plate 42 at a point opposite the intended location of the dimple 76 on the first surface 44 thereof. In some embodiments, the dimple 76 provides a point of contact between the first surface 44 of the compression plate 42 and a panel or other object against which the compression nut 14 abuts when in the initial retracted state. When the panel is not yet provided, such as prior to installation, or when an opening in the panel allows for the compression plate 42 to be entirely received therein, the dimple 76 abuts against the second surface 20 of the base plate 16. The dimple 76 functions as a stanchion and ensures a frictional hold preventing the compression nut 14 and the base nut 12 from separating prior to installation. In some embodiments, the compression nut 14 may include a plurality of dimples 76 equidistantly spaced apart from one another and provided proximate the edge surface 48 of the compression plate 42. However, the dimples 76 may be located in any suitable location and arrangement, such as located closer toward a center of the compression plate 42 and closer to the compression shaft 50. In embodiments in which the compression plate 42 includes the dimple 76, it should be appreciated that providing at least two opposing dimples 76 or a plurality of equidistantly spaced apart dimples 76 will improve the stability of the compression plate 42 on a panel as opposed to the stability provided by only a single dimple 76.

In some embodiments, an elastomer 78 may be provided on the first surface 44 of the compression plate 42. The elastomer 78 may be adhered onto the first surface 44 of the compression plate 42 at a single spot or, alternatively, may be a ring encircling the compression channel 52. The dimple 76 and the elastomer 78 each, whether utilized individually or in combination, prevent loosening of the compression nut 14 with respect to the base nut 12 prior to installation and prevents contact between the first surface 44 of the compression nut 14 and the second surface 20 of the base nut 12.

In some embodiments, a deformation 79 is formed in the exterior surface 60 of the compression shaft 50 proximate the second open end 56 of the compression channel 52. The deformation 79 may be formed by indenting a portion of the compression shaft 50. The deformation 79 restricts complete removal of the compression nut 14 from the base nut 12 as the compression nut 14 moves toward the extended state. Specifically, when the deformation 79 contacts the base shaft 24, further extension of the compression nut 14 is prevented. Alternatively, in some embodiments, the deformation 79 may be formed by attaching an obstruction, forming a projection, by any suitable means, such as welding, an adhesive, or the like.

As shown in FIG. 2, a fastener 80 is utilized to engage the compression nut 14 and cause the compression nut 14 to engage the base nut 12. As such, the fastener 80 may be any suitable fastener for engaging the internal threads 64 of the compression nut 14. Thus, the fastener 80 includes a fastener shaft 82 having a plurality of external threads 83 for engaging the internal threads 64 of the compression shaft 50. The fastener shaft 82 of the fastener 80 has a first end 84 and an opposite second end 86. The fastener 80 includes a head 88 formed at the first 84 end of the fastener shaft 82 and has a first surface 90 and an opposite second surface 92.

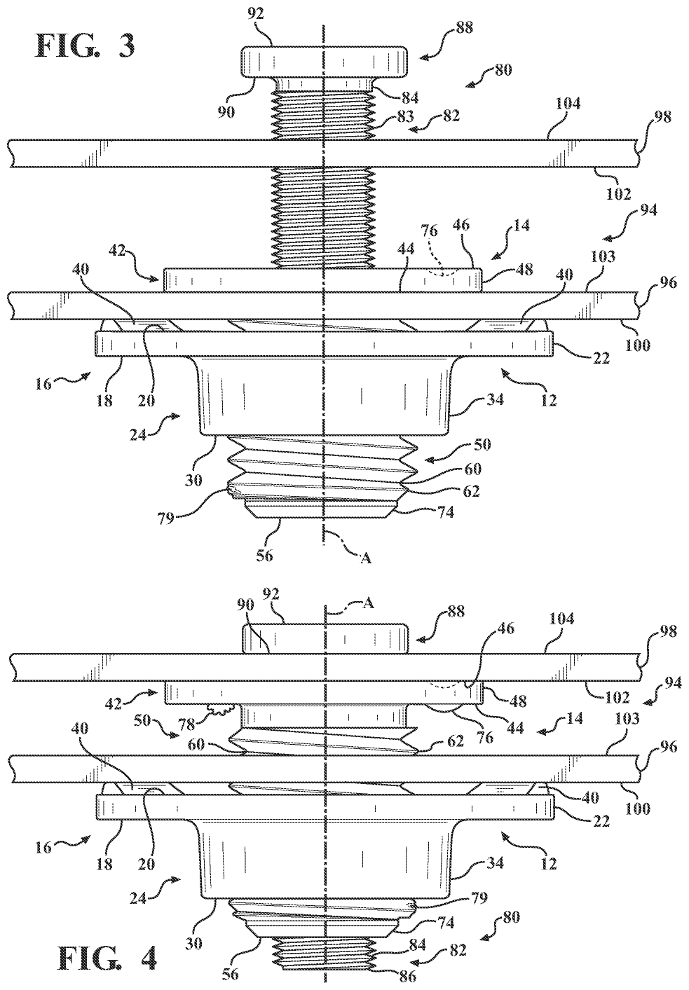

Referring now to FIG. 3, the compression nut assembly 10 is shown assembled with the compression nut 14 in the retracted state with respect to the base nut 12. In use, the compression nut assembly 10 is utilized to compensate for a gap or space 94 between two objects, such as a first panel 96 and a second panel 98. As shown, the first panel 96 and the second panel 98 are planar members, such as sheet materials. However, it should be appreciated that the first panel 96 and the second panel 98 may be any suitable objects having a space provided therebetween which must be compensated for to eliminate or mitigate the potential for damage during movement and/or vibration. In some embodiments, the base nut 12, specifically the base plate 16, is initially secured to a first surface 100 of the first panel 96. As noted above, the projection 40, or plurality of projections 40, if provided, may be welded or otherwise secured in any suitable manner to the first surface 100 of the first panel 96. Thus, the first panel 96 is initially positioned and sandwiched between the base plate 16 and the compression plate 42 as the compression plate 42 abuts against a second surface 103 of the first panel 96 when the compression plate 42 in the retracted state. However, it is to be understood that the compression plate 42 does not need to be in physical contact with first panel 96. As shown in FIG. 3, the compression plate 42 rests on the second surface 103 of the first plate 96. However, it is understood that the first plate 96 may have an opening through which the compression nut 14 extends that is large enough such that the compression plate 42 may be received therein and contact the base plate 16. The dimple 76 and the elastomer 78 thus prevent contact between the first surface 44 of the compression plate 42 and the second surface 20 of the base plate 16 in such instances. The dimple 76 also ensures that the compression nut 14 is level with respect to the base nut 12 when in the initial retracted state.

As shown in FIG. 3, and with reference to FIG. 2, the fastener 80 extends through the second panel 98 and engages the compression nut 14. As noted herein, the resistance layer 66 causes resistance between the fastener 80 and the compression nut 14. Thus, rotation of the fastener 80 in a first direction initially results in rotation of the compression nut 14 in a first direction with respect to the base nut 12, as opposed to rotation of the fastener 80 with respect to the compression nut 14. However, if the resistance layer 66 is not provided, it is understood that rotation of the fastener 80 in the first direction may result in initial engagement of the fastener 80 with the compression nut 14. Thereafter, the compression nut 14 will move toward the extended state.

Due to the external threads 62 of the compression nut 14 and the internal threads 36 of the base nut 12 arranged in a first handedness direction, i.e., right-handed/left-handed, opposite a second handedness direction of the internal threads 64 of the compression nut 14, rotation of the compression nut 14 in the first direction results in the compression nut 14 extending out of the base nut 12 and toward the second panel 98. For example, in instances in which the internal threads 64 of the compression nut 14 are right-handed threads, the first direction is a clockwise direction. Similarly, in instances in which the internal threads 64 of the compression nut 14 are left-handed threads, the first direction is a counterclockwise direction.

As shown in FIG. 4, continued rotation of the fastener 80 in the first direction causes the compression nut 14 to move into the extended state such that the second surface 46 of the compression plate 42 contacts a first surface 102 of the second panel 98. In the extended state, the compression nut 14 extends entirely within the space 94 provided between the first panel 96 and the second panel 98. As such, a distance between the first panel 96 and the second panel 98 is compensated for to prevent damage during movement and vibration of the first panel 96 and the second panel 98. Once the second surface 46 of the compression plate 42 contacts the first surface 102 of the second panel 98, further rotation of the fastener 80 causes the fastener 80 to extend further through the compression nut 14 and the base nut 12 toward the first panel 96. As shown in FIG. 4, the fastener 80 is rotated in the first direction until the first surface 90 of the head 88 of the fastener 80 comes into contact with a second surface 104 of the second panel 98 to secure the second panel 98 between the head 88 of the fastener 80 and the compression plate 42 of the compression nut 14.

It should be appreciated that the above operation may be performed in the reverse order by rotating the fastener 80 in an opposite second direction opposite the first direction to move the compression nut 14 back toward the retracted state within the base nut 12 and remove the fastener 80 from the compression nut 14. Due to the resistance between the internal threads 64 of the compression nut 14 and the external threads 83 of the fastener 80, rotation of the fastener 80 in the second direction initially rotates the compression nut 14 in the same second direction, toward the first panel 96 and toward the retracted state. Once the first surface 44 of the compression plate 42 contacts a second surface 104 of the first panel 96, continued rotation of the fastener 80 in the second direction causes the fastener 80 to move away from the second panel 98 and out of the compression nut 14.

It should be appreciated that the length of the compression shaft 50 may be any suitable length to ensure that the compression nut 14 extends out of the base nut 12 and toward the extended state to contact the second panel 98 without fully disengaging from the base nut 12. Therefore, when the distance between the first panel 96 and the second panel 98 is greater, the length of the compression shaft 50 will also be greater. Alternatively, it should be appreciated that, in some embodiments, the length of the compression shaft 50 may remain the same, but the thickness of the compression plate 42, i.e., the edge surface 48, may be increased to account for changes in distances between the first panel 96 and the second panel 98.

Although the internal threads 36 of the base shaft 24 and the external threads 62 of the compression shaft 50 are referred to herein as being left-handed threads and the internal threads 64 of the compression shaft 50 is referred to as being right-handed threads, it should be appreciated that the present disclosure is not limited to this embodiment. As such, it is contemplated that in an embodiment, the internal threads 36 of the base shaft 24 and the external threads 62 of the compression shaft 50 may be right-handed threads and the internal threads 64 of the compression shaft 50 may be left-handed threads. This would also result in a left-handed threaded fastener initially causing the compression nut 14 to move toward the extended state and, subsequently, the fastener to extend through the compression nut 14 and the base nut 12. Therefore, it should be noted that the scope of the present disclosure is directed toward the internal threads 36 of the base shaft 24 and the external threads 62 of the compression shaft 50 extending in an opposite handedness direction than that of the internal threads 64 of the compression shaft 50.

From the above, it is to be appreciated that defined herein is a compression nut assembly extendable between a pair of opposing objects to mitigate damage caused by movement and vibration of the pair of opposing objects with respect to one another.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A compression nut assembly comprising:
a base nut including a base shaft having an interior surface and an exterior surface, the interior surface of the base shaft including a plurality of internal threads extending in a first handedness direction;
a compression nut including a compression shaft having an interior surface and an exterior surface, the exterior surface of the compression shaft including a plurality of external threads extending in the first handedness direction and engagable with the internal threads of the base shaft, the interior surface of the compression shaft including a plurality of internal threads extending in a second handedness direction opposite the first handedness direction.

2. The compression nut assembly of claim 1, wherein the base nut further comprises a base plate having a first surface and an opposite second surface, the base shaft extending from the first surface of the base plate.

3. The compression nut assembly of claim 2, wherein the base plate further comprises at least one projection extending in a direction opposite the base shaft.

4. The compression nut assembly of claim 3, wherein the base plate has an edge surface extending between the first surface of the base plate and the second surface of the base plate, the at least one projection positioned proximate the edge surface.

5. The compression nut assembly of claim 3, wherein the base plate further comprises a plurality of projections equidistantly spaced apart from one another.

6. The compression nut assembly of claim 2, wherein the interior surface of the base shaft defines a base channel extending through the base plate.

7. The compression nut assembly of claim 1, wherein the compression nut further comprises a compression plate having a first surface and an opposite second surface, the compression shaft extending from the first surface of the compression plate.

8. The compression nut assembly of claim 7, wherein the compression plate further comprises at least one dimple extending in the same direction as the compression shaft.

9. The compression nut assembly of claim 8, further comprising a plurality of dimples equidistantly spaced apart from one another.

10. The compression nut assembly of claim 7, wherein the compression plate further comprises an elastomer adhered to the first surface of the compression plate.

11. The compression nut assembly of claim 5, wherein the interior surface of the compression shaft defines a compression channel extending through the compression plate.

12. The compression nut assembly of claim 11, wherein the interior surface of the compression shaft includes a threaded section having a first diameter and an unthreaded section having a second diameter less than the first diameter, the plurality of internal threads of the compression shaft provided on the threaded section of the compression channel.

13. A compression nut assembly comprising:
a base nut including a base plate having a first surface and a second surface, and a base shaft extending from the first surface of the base plate, the base shaft having an interior surface and an exterior surface, the interior surface of the base shaft including a plurality of internal threads extending in a first handedness direction;
a compression nut including a compression plate having a first surface and a second surface, and a compression shaft extending from the first surface of the compression plate, the compression shaft having an interior surface and an exterior surface, the exterior surface of the compression shaft including a plurality of external threads extending in the first handedness direction and engagable with the internal threads of the base shaft, the interior surface of the compression shaft including a plurality of internal threads extending in a second handedness direction opposite the first handedness direction.

14. The compression nut assembly of claim 13, wherein the plurality of internal threads of the compression shaft are right-handed threads, and the external threads of the compression shaft and the internal threads of the base shaft are left-handed threads.

15. The compression nut assembly of claim 13, wherein the plurality of internal threads of the compression shaft are left-handed threads, and the external threads of the compression shaft and the internal threads of the base shaft are right-handed threads.

16. A method for expanding a compression nut assembly between a first object and a second object, comprising:
threadedly engaging a compression nut with a base nut, the compression nut including a plurality of external threads engaging a plurality of internal threads of the base nut, the base nut fixed to the first object, the compression nut movable between a retracted state and an extended state;
threadedly engaging a fastener with a plurality of internal threads of the compression nut;
rotating the fastener in a first direction to move the compression nut toward the extended state until the compression nut extends entirely between a space provided between the first object and the second object; and
rotating the fastener in the first direction such that the fastener further engages the compression nut.

17. The method of claim 16, wherein the plurality of internal threads of the compression shaft are right-handed threads, and the external threads of the compression nut and the internal threads of the base nut are left-handed threads.

18. The method of claim 17, wherein the first direction is a clockwise direction.

19. The method of claim 16, wherein the plurality of internal threads of the compression nut are left-handed threads, and the external threads of the compression nut and the internal threads of the base nut are right-handed threads.

20. The method of claim 16, wherein when the compression nut is in the retracted state a greater number of external threads of the compression nut engage the internal threads of the base nut as compared to the number of external threads of the compression nut that engage the internal threads of the base nut when the compensation nut is in the extended state.
